(19) United States
(12) Patent Application Publication
(10) Pub. No.: US 2009/0012708 A1
(43) Pub. Date: Jan. 8, 2009

(54) Personal navigation devices and related methods

(76) Inventors: Jui-Chien Wu, Taipei City (TW); Jui-Jun Shyur, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(21) Appl. No.: 12/007,049

(22) Filed: Jan. 4, 2008

(30) Foreign Application Priority Data
Jan. 5, 2007 (TW) 096100472

(51) Int. Cl. G01C 21/00; H04N 5/228

(52) U.S. Cl. 701/213; 348/222.1; 348/E05.031

(57) ABSTRACT

A Personal Navigation Device (PND) includes: a Global Positioning System (GPS) module, a processing module, and a user interface module. The GPS module generates a current location value. The processing module, which is coupled to the GPS module, is utilized for comparing the current location value and a plurality of hint points. The user interface module, which is coupled to the processing module, provides a display device. When a difference between the current location value and any hint point is less than a first threshold, the display device displays stored real image data corresponding to the hint point.

### BACKGROUND OF THE INVENTION

1. Field of the Invention

The present invention relates to the Global Positioning System (GPS), and more particularly, to Personal Navigation Devices and related methods.

2. Description of the Prior Art

Utilization of the Global Positioning System is limited to the military of the United States in early periods. Today, the Global Positioning System has been released to the civilians for positioning. Accordingly, the positioning technology utilizing satellite signals is rising and flourishing developing on the market. Typically, related products of the classic Global Positioning System not only provide positioning information exactly, but also accurately provide related information such as speed, time, direction, and distance, through calculation.

According to the prior art, a typical navigation device implemented by applying Global Positioning System-related technology usually includes a display module for displaying maps, the user's location, and direction indication, where the display module can display the maps according to various viewing angles and/or vantage points. However, no matter what angle and vantage point are utilized by the navigation device to display a map (e.g. displaying the map as seen from a driver looking around or simply displaying the map with a bird's-eye view), it is difficult to read the map for the user. More particularly, when the user is driving the car on the road through various landscapes in downtown, because of interference of various traffic lights, buildings, and various signboards, it is hard for the user to exactly determine the relationships between real view seen by himself/herself and the map displayed on the display module.

### SUMMARY OF THE INVENTION

It is an objective of the claimed invention to provide Personal Navigation Devices (PNDs) and related methods.

A Personal Navigation Device according to an embodiment of the claimed invention comprises: a Global Positioning System (GPS) module, for generating a current location value; a processing module, coupled to the Global Positioning System module, for comparing the current location value and a plurality of hint points; and a user interface module, coupled to the processing module, the user interface comprising a display device, where when a difference between the current location value and any hint point is less than a first threshold, the display device displays stored real image data corresponding to the hint point.

A method of controlling operations of a Personal Navigation Device according to an embodiment of the present invention is further disclosed. The Personal Navigation Device comprising a Global Positioning System, a storage unit, and a display device module, the method comprising (a) generating a current location value by utilizing the Global Positioning System module; (b) examining whether the storage unit stores at least one hint point and real image data corresponding to the hint point; and (c) when a difference between the current location value and any hint point is less than a first threshold, the display device displaying the real image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a Personal Navigation Device according to one embodiment of the present invention.

FIG. 2 is a flowchart of a method of controlling operations of the Personal Navigation Device according to the embodiment shown in FIG. 1.

FIG. 3 is a diagram of a Personal Navigation Device according to another embodiment of the present invention.

### DETAILED DESCRIPTION

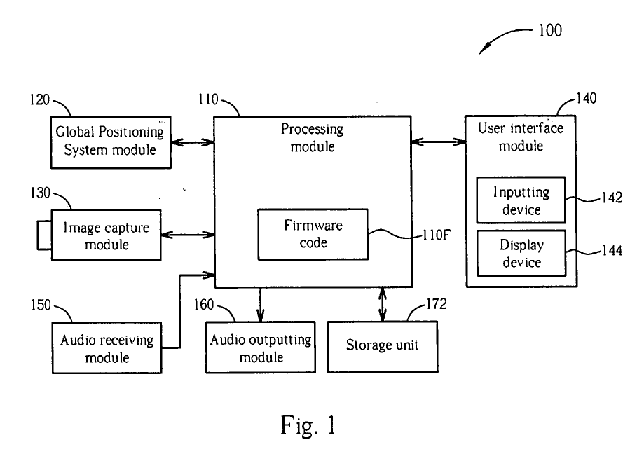

Please refer to FIG. 1. FIG. 1 is a diagram of a Personal Navigation Device according to one embodiment of the present invention, where the Personal Navigation Device can be a Personal Digital Assistant (PDA). As shown in FIG. 1, the Personal Navigation Device 100 comprises: a processing module 110, a Global Positioning System module 120, an image capture module 130, a user interface module 140, an audio receiving module 150, an audio outputting module 160, and a storage unit 172. In addition, the user interface module 140 comprises: an inputting device 142 such as touch panel for inputting information, and a display device 144 such as a liquid crystal display (LCD) for displaying information. The implementation of the touch panel mentioned above is well known in the art, and therefore not explained in detail here.

The processing module 110 controls operations of the Personal Navigation Device 100 according to a program code (not shown in the diagram), where the program code comprises a firmware code 110F. The Global Positioning System, module 120 is capable of detecting and/or examining the user's location to generate a current location value. This can be achieved by generating a plurality of sets of coordinate values respectively corresponding to a plurality of time points according to satellite signals (for example, the coordinate values representing the longitude, latitude, and altitude), where the coordinate values can be utilized by the processing module 110, with the plurality of sets of coordinate values comprising the current location value.

The firmware code 110F of the processing module 110 can be utilized for comparing the current location value and a plurality of hint points which are stored in the storage unit 172. When the current location value is close to a hint point (i.e. a difference between the current location value and one of the hint points is less than a first threshold), it means that the user's current location is close to the hint point of the path. In this situation, the firmware code 110F is executed to generate path information of at least one path, and to obtain a corresponding image near the current set of coordinate values along the path. As a result, the processing module 110 is capable of obtaining the real image data corresponding to the hint points according to the plurality of hint points on reference paths provided by the program code in advance, and is capable of displaying the path information (for example, an altered map with sign(s) or instructions displayed thereon) and the real image data (for example, digital photos or video clips) by utilizing the display device 144, so as to make the user rapidly move forward to a destination according to the real image data.

Generating the real image data mentioned above can be completed by a service provider through capturing at the hint points in advance, so the user may download in real time or in advance through the Internet. Of cause, Generating the real image data mentioned above can be completed by the user, too. The user may build the real image data through the image capture module 130, the Global Positioning System module 120, and the processing module 110 for another user's reference. For example, the user is following a current moving direction of the path and approaching a location where the user should turn right, where the image displayed on the display device 144 can be a real image as seen along the current moving direction, and can be a model image representing the real image (for example, the image of three-dimensional model representing a certain building). According to another preferred implementation choice of this embodiment, the image displayed on the display device 144 also can be a hybrid image which is generated by adding a certain symbol, such as an arrowhead, on the real image, where the arrowhead clearly indicates that the user should turn right in front of the red building, in order to guide the user to quickly understand the correct direction and destination.

According to this embodiment, the method for generating the image data of the image mentioned above in advance can be described as follows. The processing module 110 executing the firmware code 110F can utilize the image capture module 130 to perform image capture, in order to generate the image data of the image in advance. The user may trigger an automatic capture function provided by the firmware code 110F through the inputting device 142, so as to perform image capture of various locations in advance anytime. Accordingly, the processing module 110 executing the firmware code 110F can store the image data of the images corresponding to the locations in the hint database, so the image data can be utilized as the above-mentioned image data of the image near the current set of coordinate values on the path when needed, where the image data corresponds to the current moving direction. In addition, the processing module 110 executing the firmware code 110F can also control the Personal Navigation Device 100 to input the image data of images of several locations from an external device, so the image data can be utilized as the above-mentioned image data of the image near the current set of coordinate values on the path when needed, where the image data corresponds to the current moving direction.

According to this embodiment, the hint database mentioned above is implemented by utilizing the storage unit 172, and the storage unit 172 is a non-volatile memory, for example, a Flash memory. In addition, the hint information stored in the hint database implemented by utilizing the storage unit 172 further comprises at least one audio message corresponding to the image, where the audio message is prerecorded. In this embodiment, the audio receiving module 150 can be utilized for receiving audio waves, and the processing module 110 executing the firmware code 110F performs prerecording of the audio message corresponding to the image, and controls the audio outputting module 160 to play back the audio message when the display device 144 displays the image. Similarly, the processing module 110 executing the firmware code 110F may also control the Personal Navigation Device 100 to input the prerecorded audio message from an external device.

It is noted that whether the hint database stores the set of coordinate values corresponding to the image data of image of various locations doesn't hinder the implementation of the present invention. If the hint database stores the set of coordinate values corresponding to the image data of image of various locations, the processing module 110 executing the firmware code 110F may attain the image data of image corresponding to a certain set of coordinate value near the set of current coordinate values in the hint database; otherwise, the processing module 110 executing the firmware code 110F may also attain the image data of the image corresponding to a certain set of coordinate value near the current set of coordinate values in the hint database, according to the captured time of each image and the plurality of sets of coordinate values respectively corresponding to the plurality of time points, where the plurality of sets of coordinate values are generated by the Global Positioning System module 120 and can be stored in the storage unit 172.

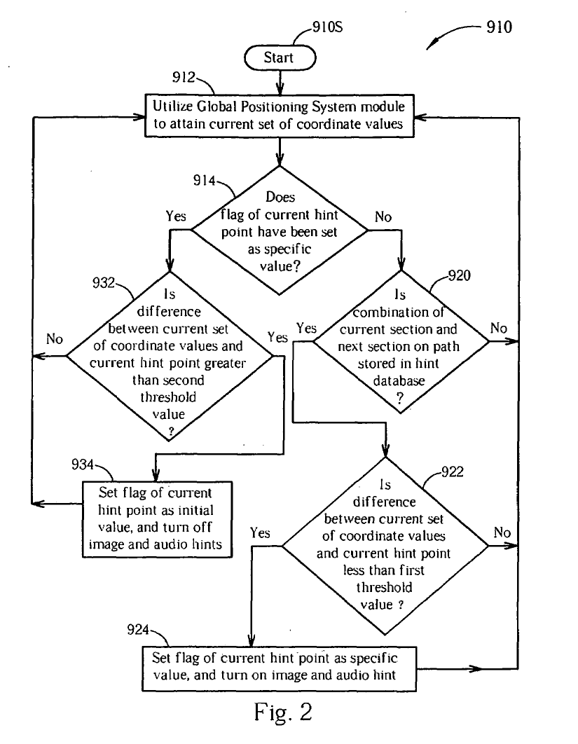

Please refer to FIG. 2, which is a flowchart of a method of controlling operations of the Personal Navigation Device provided by the embodiment shown in FIG. 1, where the method 910 represents at least one portion of controlling flows provided by the firmware code 110F, and can be described as follows.

In Step 912, the processing module 110 utilizes the Global Positioning System module 120 to attain the current set of coordinate values (which represent the current location).

In Step 914, the processing module 110 executing the firmware code 110F determines whether a flag of a current hint point (for example, the above-mentioned turn right corner) on a path has been set as a specific value, where a typical hint point on the path usually corresponds to an intersection. In this embodiment, an initial value of the flag is equal to 0, which represents “turning off the image and audio hint”, and the specific value is equals to 1, which represents “turning on the image and audio hint”. If the flag of the current hint point has been set as the specific value, enter Step 932; otherwise, enter Step 920.

In Step 920, the processing module 110 executing the firmware code 110F determines whether a combination of a current section and the next section on the path (the combination typically represents an intersection, which can be an intersection for turning left/right, or an intersection for straight crossing) is stored in the hint database. According to this embodiment, this step may perform the determination mentioned above by examining whether the hint database stores a certain set of coordinate values near the set of current coordinate values. If the combination exists in the hint database, enter Step 922; otherwise, enter Step 912.

In Step 922, the processing module 110 executing the firmware code 110F determines whether a difference between the current set of coordinate values and the current hint point is less than a first threshold value, where the first threshold value can be several meters, ten or more meters, or several decameters. If the difference is less than the first threshold value, enter Step 924; otherwise, enter Step 912.

In Step 924, the processing module 110 executing the firmware code 110F sets the flag of the current hint point as the specific value, and turns on the image and audio hint.

In Step 932, the processing module 110 executing the firmware code 110F determines whether the difference between the current set of coordinate values and the current hint point is greater than a second threshold value, where whether the second threshold value equals to the first threshold value doesn't hinder the implementation of the present invention. If the difference is greater than the second threshold value, enter Step 934; otherwise, enter Step 912.

In Step 934, the processing module 110 executing the firmware code 110F sets the flag of the current hint point as the initial value, and turns off the image and audio hints.

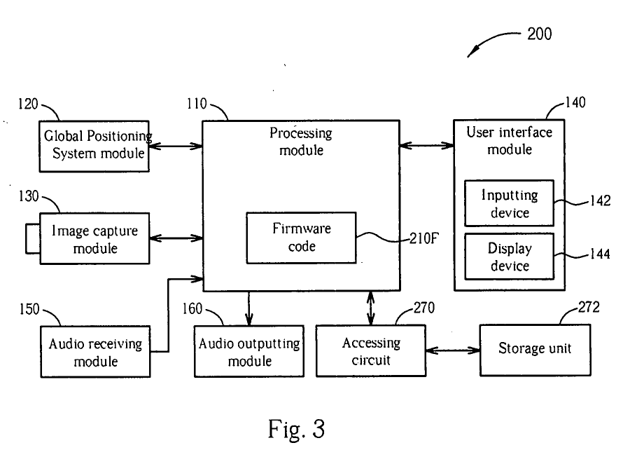

Please refer to FIG. 3, which is a diagram of a Personal navigation Device 200 provided according to a second embodiment of the present invention. The difference between the Personal Navigation Device 200 and the Personal Navigation Device 100 of the first embodiment can be described as follows. In this embodiment, the storage unit 272 can be accessed by utilizing the accessing circuit 270, which is provided in accordance with the variation of the above-mentioned hardware architecture in contrast to the embodiment shown in FIG. 1. The processing module 110 can utilize the accessing circuit 270 to read the real image data and at least one corresponding audio message stored in the storage unit 272, and play back the audio message through the audio outputting module 160 when display device 144 displays the image.

In contrast to the prior art, the user can exactly determine the relationship between a real view seen by himself/herself and the path information displayed by the display device 144 (for example, a map with path notations added thereon) in real time according to the hint information displayed by the Personal Navigation Device and related methods of the present invention, and more particularly, according to the above-mentioned image near the current set of coordinate values along the path, and corresponding to the current moving direction. Therefore, the Personal Navigation Device and related methods of the present invention can achieve better navigation performance in contrast to the prior art. It is another advantage of the present invention that the at least one audio message corresponding to the image can further enhance the navigation performance of the Personal Navigation Device and related methods of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A Personal Navigation Device (PND) comprising:
a Global Positioning System (GPS) module, for generating a current location value;
a processing module, coupled to the GPS module, for comparing the current location value and a plurality of hint points; and
an user interface module, coupled to the processing module and providing a display device, wherein when a difference between the current location value and any hint point is less than a first threshold, the display device displays stored real image data corresponding to the hint point.

2. The Personal Navigation Device of claim 1, wherein the real image data is data generated by capturing at a location of the hint point.

3. The Personal Navigation Device of claim 1, further comprising:
a storage unit, for storing the real image data;
wherein the processing module reads the real image data from the storage unit, and the real image data is displayed by utilizing the display device.

4. The Personal Navigation Device of claim 3, further comprising:
an accessing circuit, coupled between the processing module and the storage unit, for accessing the real image data in the storage unit, and transferring the real image data to the processing module.

5. The Personal Navigation Device of claim 4, wherein the storage unit is a memory card.

6. The Personal Navigation Device of claim 1, further comprising:
an image capture module, coupled to the processing module, for performing image capture to generate the real image data.

7. The Personal Navigation Device of claim 1, wherein the real image data is provided through an external network.

8. The Personal Navigation Device of claim 1, further comprising:
an audio receiving module, coupled to the processing module, wherein when the audio receiving module receives an audio signal, the processing module generates a pre-recorded audio message; and
an audio outputting module, coupled to the processing module, for playing the pre-recorded audio message.

9. The Personal Navigation Device of claim 1, further comprising:
an audio outputting module, coupled to the processing module, for playing an audio message corresponding to the real image data when the display device displays the real image data.

10. A method of controlling operations of a Personal Navigation Device, the Personal Navigation Device comprising a Global Positioning System (GPS), a storage unit, and a display device module, the method comprising:
(a) generating a current location value by utilizing the Global Positioning System module;
(b) examining whether the storage unit stores at least one hint point and real image data corresponding to the hint point; and
(c) when a difference between the current location value and any hint point is less than a first threshold, the display device displaying the real image data.

11. The method of claim 10, wherein the Personal Navigation Device provides an audio outputting module; and in step (c), when the display device displays the real image data, the voice outputting module plays an audio message corresponding to the real image data.

12. The method of claim 10, further comprising
(d) when a difference between the current location value and any of all hint points is greater than a second threshold, turning off the display device.

13. The method of claim 10, wherein the hint point and the real image data corresponding to the hint point are downloaded from a network.

14. The method of claim 10, wherein the hint point and the real image data corresponding to the hint point are capable of being generated by utilizing the Global Positioning System module and a processing module and an image capture module of the Personal Navigation Device.
